(19) United States
(12) Patent Application Publication
(10) Pub. No.: US 2016/0210413 A1
(43) Pub. Date: Jul. 21, 2016

(54) METHOD AND SYSTEM FOR USER MANAGED HEALTH CARE

(71) Applicants: Kamran Janjua, Eagle River, AK (US); Hiren Bhavsar, Duvall, WA (US)

(72) Inventors: Kamran Janjua, Eagle River, AK (US); Hiren Bhavsar, Duvall, WA (US)

(21) Appl. No.: 14/796,256

(22) Filed: Jul. 10, 2015

Related U.S. Application Data
(60) Provisional application No. 62/023,861, filed on Jul. 12, 2014.

(51) Int. Cl. G06F 19/00

(52) U.S. Cl. CPC G06F 19/322; G06F 19/321

(57) ABSTRACT

A method and system for users managing their medical data is disclosed. The user's medical data comprises a medical data file having metadata stored directly within the data set, presently leveraging the DICOM standard but broadly applicable to it and other metadata-bearing imaging standards. In use, a series of these medical data files are received by a processing server wherein personal information is redacted (either automatically or by an independent party) from the data set in accordance with HIPAA and then transmitted to one or more facilitators as directed by the user's inputs via a network connection wherein the data transmission of these medical data files are compliant with the DICOM communication protocol or future standards. Additionally, the method allows users to make better informed medical decisions on procedures such as surgeries to disease management by looking at factors such as price, expertise, and other fit parameters.

### TECHNICAL FIELD

The present invention generally relates to medical data processing. More specifically, to the extraction and/or creation and use of metadata from medical data transmissions, such as metadata stored within images compliant with the DICOM (Digital Imaging and Communications in Medicine) standard, and related processes.

### BACKGROUND ART

Medical data of users generated by an imaging modality, such as X-rays, CT (Computerized Tomography) scans, and MRI (Magnetic Resonance Imaging) scans, or by clinicians in a care setting, are commonly presented in digital format to facilitate rapid distribution, storage, and assessment by local or remote providers. These medical data are typically transmitted via an electronic server and hosting medium, such as a Radiology Information System (RIS), Picture Archiving and Communications System (PACS), Electronic Medical Record (EMR), Electronic Health Record (EHR), or similar such system, to a relevant health data consumer. This transmission may occur over a network, such as an intranet or the Internet.

In use, medical practices generally route these medical data to providers in a fixed manner out of a user's control. For example, all of a user's medical images may be transmitted to a set of doctors that work in a radiology department of a hospital where the images are produced wherein a generated diagnostic report is shared primarily between doctors. After receipt of such images, the health care provider may interpret the study and return a diagnostic report to the same hospital or health care network. However, a need exists for a user to control, manage, and transmit his or her medical data through a HIPAA compliant network to one or more health care providers, thereby enabling receipt of one or more case assessments and/or content relating to potential costs of care from similar cases in a manner consistent with state, national, and international health care medical practice laws. A byproduct of these operations is the creation and classification of medical data into groups that enable further analysis. The present invention solves this and many other problems in a novel and unique manner.

### SUMMARY OF THE INVENTION

A method and system for users managing their medical data is disclosed. The users' medical data comprises data files containing metadata stored directly within the data file, and that primarily leverages the use of the DICOM standard. It should be understood that other metadata-bearing standards may also be used with the method of the present invention. In use, a series of medical data files are received at a processing server wherein personal information is redacted (either automatically or by an independent party) from the data file in accordance with HIPAA-compliant de-identification standards. It is then transmitted to one or more health care providers (as directed by the users' inputs) via a network connection. Additionally, the data transmission of these medical data files are transmitted in compliance with the DICOM communication protocol or future protocols.

In some embodiments, a health care provider may be selected from a plurality of providers either automatically or manually (by a facilitator) based on data fields within the metadata and by information provided from a user via a case assessment request. For example, medical data values such as user identifier, user physical location, user medical condition, user concern, type of modality used to produce the series of medical images, type of procedure performed or requested by the user and type of scan for which the series of medical images relates might be used to select an appropriate health care provider recipient.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### DESCRIPTION OF THE DRAWINGS

In the accompanying drawings:

FIG. 1 is a diagram illustrating a system for user managed health care in accordance with the invention;

FIG. 2 is a block diagram of a method for medical data management according to the invention;

FIG. 3 is a block diagram of a unified method for a user to request either a virtual or in-person consultation from a health care provider according to the invention;

FIG. 4 is a block diagram of a method for a user to seek actionable medical content when managing their health care according to the invention;

FIG. 5 is a block diagram of a method for medical data collection and submission for case assessment according to the invention;

FIG. 6 is a block diagram of a method for routing user medical data according to the invention;

FIG. 7 is a block diagram of a method for facilitators to receive user case assessment requests and to generate care proposals according to the invention;

FIG. 8 is a block diagram of a method for a user selecting a care proposal when managing his or her medical data according to the invention;

FIG. 9 is a block diagram of a method for a user paying for and in return receiving care according to the invention; and

FIG. 10 is a block diagram of a method for completion of a user's care episode according to the invention.

### DESCRIPTION OF EMBODIMENTS

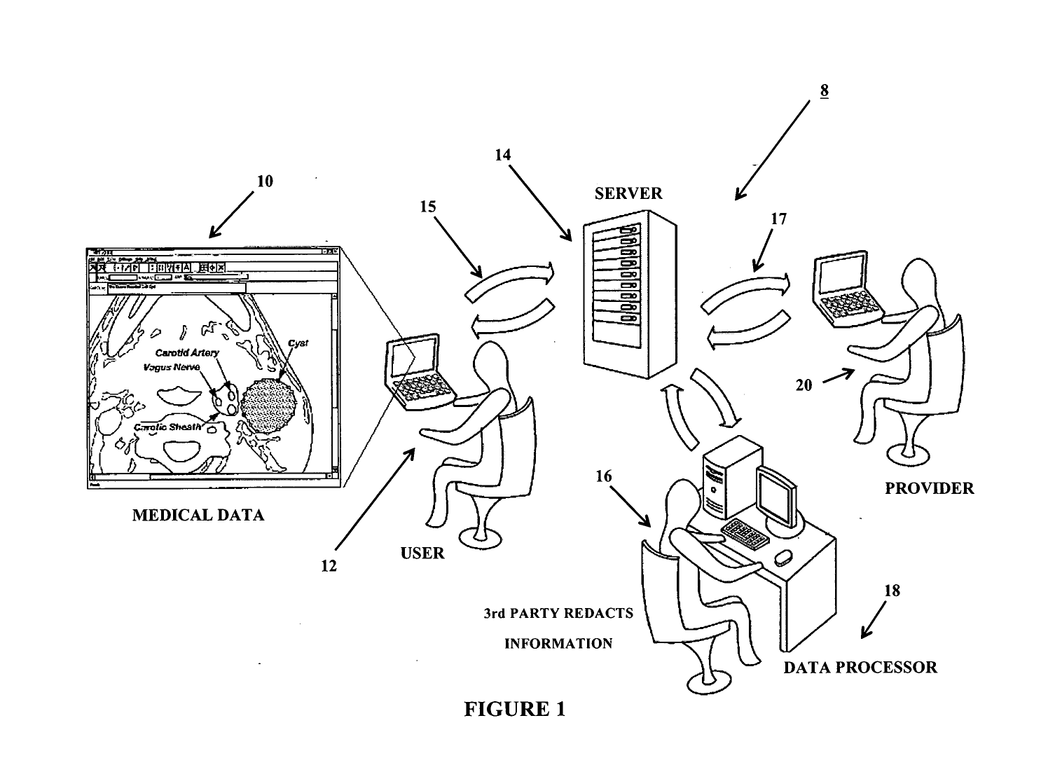

Referring now to FIG. 1 there is shown a graphical diagram of a system illustrating one type of system for user managed health care in accordance with the invention. The user's medical data 10 contains a medical data file having metadata stored directly within the data file, by using the DICOM standard. However, it should be understood that any other metadata-bearing imaging standards may be used. In use, a series of these medical data 10 files are received by a processing server 14 wherein personal information is independently redacted either automatically by a data processor 18 or by an independent party 16 from the data files by applying HIPAA's de-identification standards and then transmitted to one or more providers and/or facilitators 20 as directed by the user's 12 inputs via a network connection 15 wherein the data transmission 17 of these medical data 10 files are compliant with the DICOM communication protocol or future protocols.

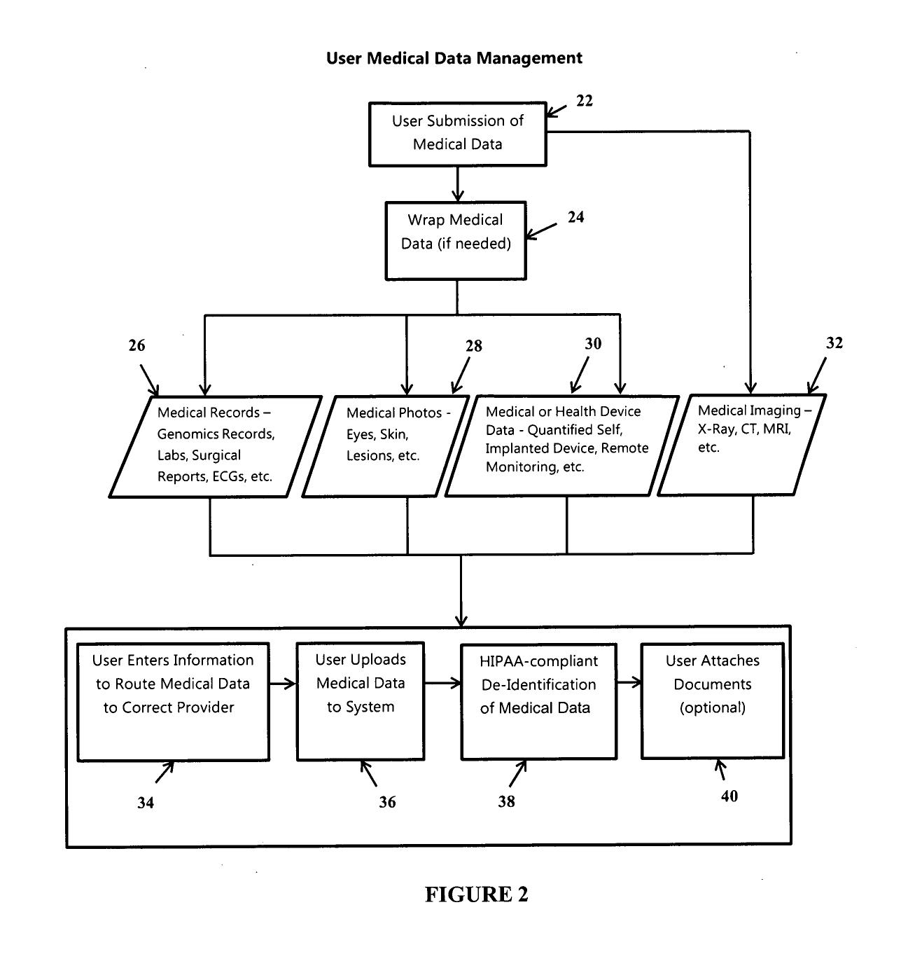

Referring now to FIG. 2 there is shown a block diagram of a flowchart of one type of method for medical data management according to the invention. As shown in FIG. 2 the first management step is to upload a user's medical data 22 which may consist of medical records such as (but is not limited to) their genomics information, laboratory results such as cholesterol, and surgical reports, etc. 24; medical photos such as those of the eyes, skin, body lesion, etc. 26; medical imaging studies, such as X-rays, CTs, MRIs, Mammograms, etc. 28 and/or health or medical device data, such as quantified self devices, implanted devices, and remote monitoring products, etc. 30. Depending on the data type being uploaded, the data may first need to be DICOM wrapped 23. Next, the user completes an electronic form to enable routing of their data 22 to an appropriately-licensed and credentialed (“qualified”) health care facilitator within an assistance network (if desired) 32, after which point the medical data is securely uploaded in a HIPAA-compliant process 34 as is known in the medical regulatory arts. Upon upload, by way of example metadata for medical imaging files may be parsed for radiation exposure dose incurred as part of the image generation process and then stored as a cumulative value that the user may then be able to track. Alternatively, such dosage values may be approximated based on assumed exposure or from actual patient data. It should be understood that all medical data are then de-identified in accordance with Title 45 C.F.R. §164.514 (a,b, and c) of the HIPAA Privacy Rule 36 with respect to any and all of the user's personal health information. The user may then attach any additional supporting documents, by way of example a user-requested physician history and physical report, to the uploaded and de-identified medical data set, if desired 38.

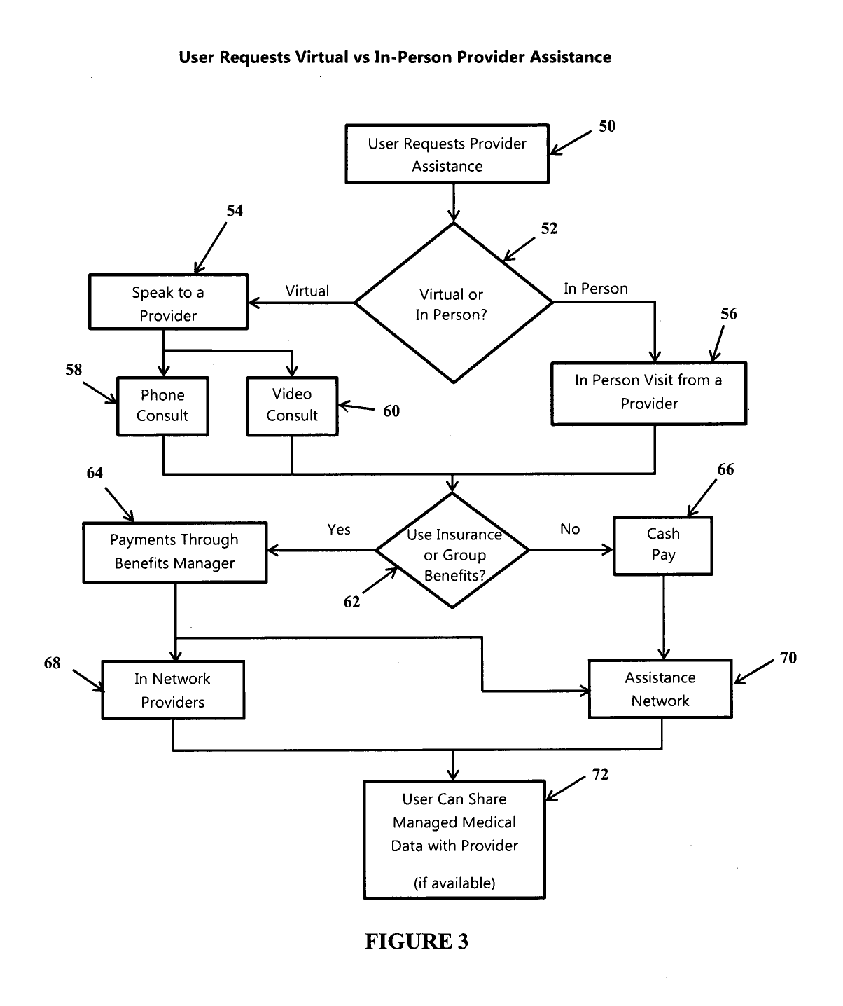

Referring now to FIG. 3 there is shown a block diagram of a flowchart for one type of method for a user to request either a virtual or in-person consultation from a health care provider according to the invention. The first step in this process involves the user making the determination that he or she wants to consult with a provider 50 and selected whether such consultation should be virtual/telemedical or via an in-person visit to the user's location at the present or at a future time 52. If the user selects to speak to a provider via a virtual consultation 54, then the user chooses whether the consult is by phone 58 or by video consultation 60. If the user selects an in-person consultation 56, then a health care facilitator from an assistance network can arrange to meet with the user at a mutually convenient time and in a mutually convenient location. Prior to either a virtual or an in-person consultation, the user will pay fees for such services that will be collected based on the arrangement under which these services are brokered. If these virtual or in-person consultations are conducted under the auspices of an insurance or benefits facilitator 62, then the payments for the user's requested services can be processed and collected 64 as per contract. If the user does not wish to use eligible insurance or group benefits or simply has neither, then the user can elect to pay cash 66 for the virtual or in-person consultation. Once payment has been processed, insurance or group benefits-covered users can be directed to either in-network providers 68 or to providers in the assistance network 70 to receive either virtual or in-person consultations from qualified providers per their original selection. Cash-pay users will receive their virtual or in-person consultations from qualified providers per their original selection from an assistance network 70. In any instance, the user may grant a designated facilitator access to the user's medical data as previously-described above and as shown in FIG. 2 or via another curated system 72.

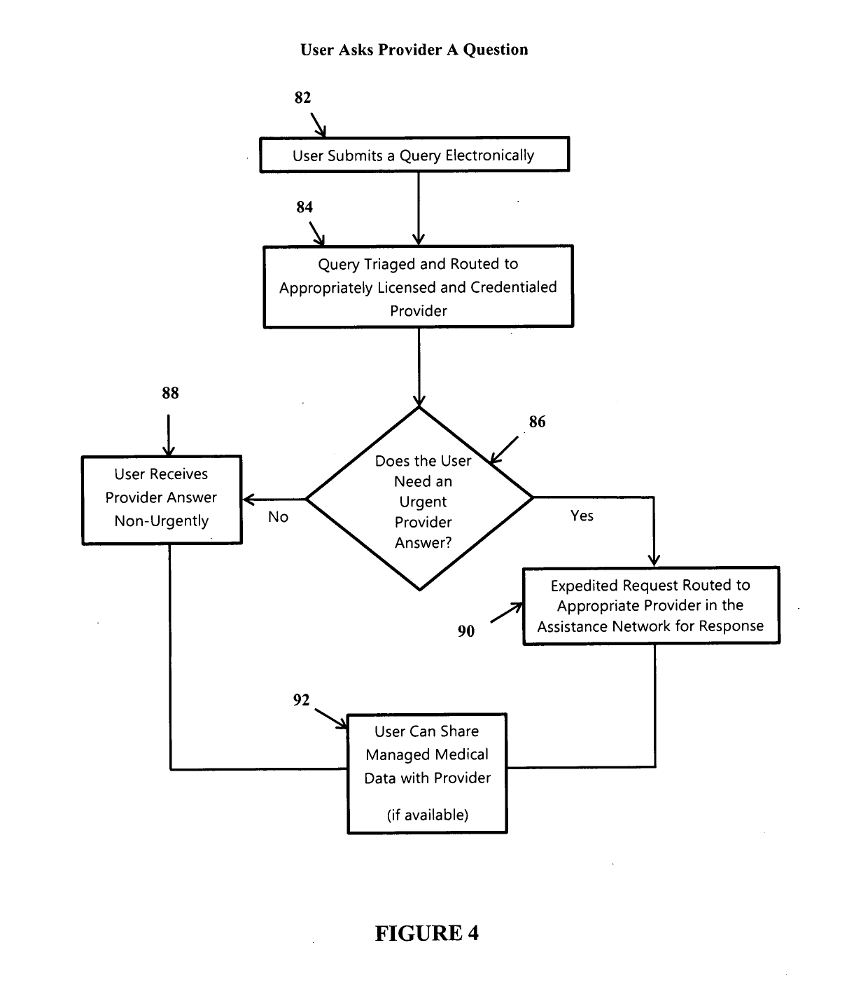

Referring now to FIG. 4 there is shown a block diagram of a flowchart for one type of method for a user to seek actionable medical content when managing their health care according to the invention. The first step in getting medical content is for the user to submit a query electronically 82. This query is then framed as a triage request and routed to an appropriately qualified health care facilitator 84. The request is then checked to see if it is an urgent request 86. If the request is not urgent a relevant answer is eventually returned to the user 88. However, if the request is urgent then the request is routed to the most readily available and appropriately qualified health care provider for immediate response 90. In any instance, the user may grant a designated provider access to the user's medical data as previously-described above and as shown in FIG. 2 or via another curated system 92.

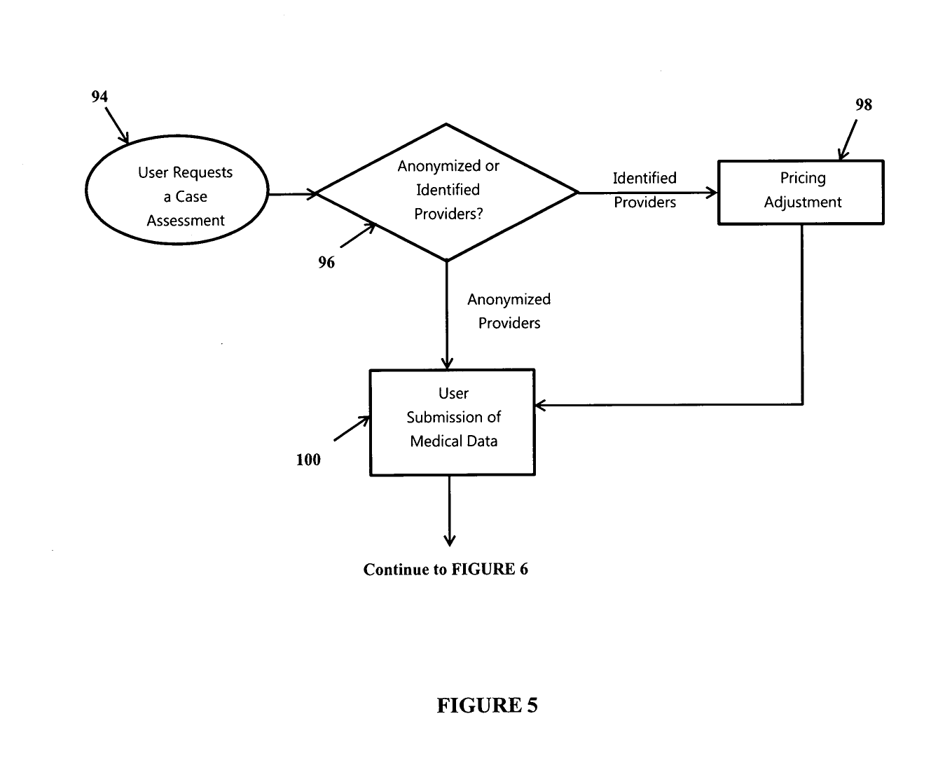

Referring now to FIG. 5 there is shown a block diagram of a flowchart of one type of method for medical data collection and submission for case assessment according to the invention. First, the user requests a case assessment 94 wherein the user next determines whether to pursue an assessment from anonymized or from identified (i.e., non-anonymized) providers 96. If the user wishes to know the identities of case assessor entities throughout the process, then a pricing premium is assessed and collected 98. If the user wishes to receive case assessments from anonymized providers then no pricing premium is assessed. Subsequently and in either case, the user submits medical data as per FIG. 2, including the upload of medical records, photos, imaging, data, and/or associated documents, among others 100. In the context of a case assessment request, the information from 32 in FIG. 2 serves as an actionable data set to enable appropriate routing to a qualified health care provider.

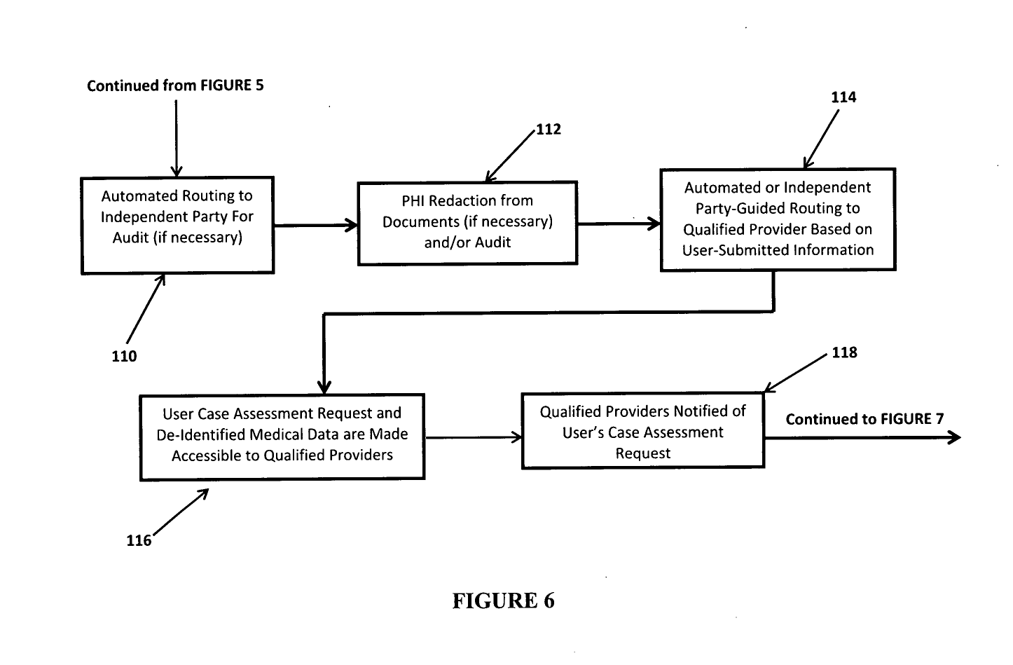

Referring now to FIG. 6 there is shown a block diagram of a flowchart of one type of method for routing user medical data according to the invention. Medical data not containing user-attached documents may be automatically or semi-automatically routed by an independent party directly to a qualified provider queue 114 based on the user-submitted data 32 as shown and described above as in FIG. 2. Medical data containing user attached documents 38 are routed to an audit queue 110 where a PHI redaction and audit 112 are performed prior to transfer of the medical data for automatic or semi-automatic routing as per 114. The user's de-identified and redacted (if necessary) medical information, along with the user's case assessment request, is then placed into a work list accessible to all qualified facilitators in the assistance network 116 who can then be notified of the user case assessment request 118.

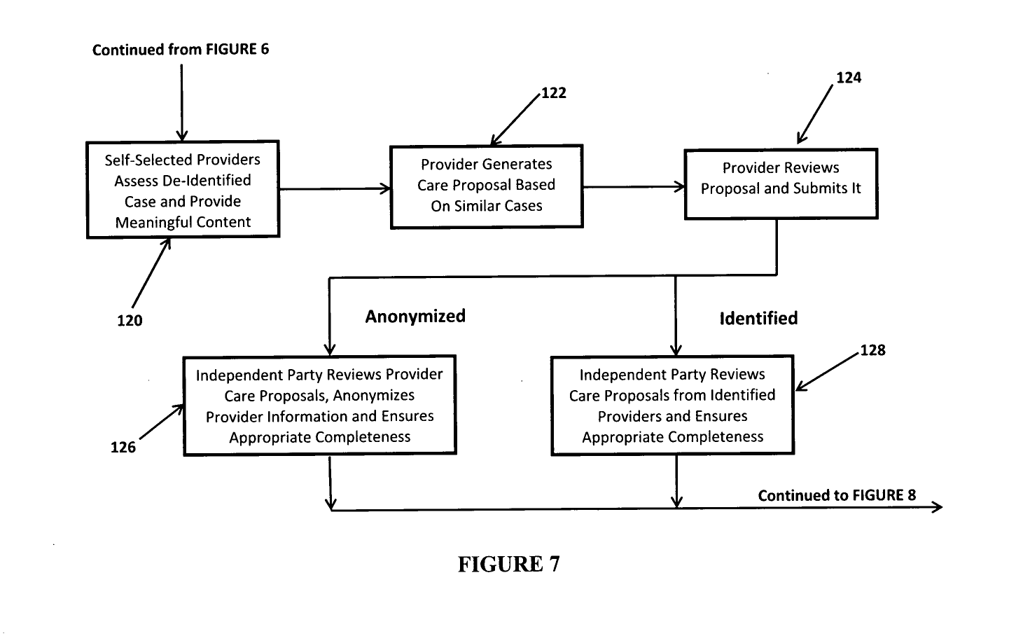

Referring now to FIG. 7 there is shown a block diagram of a flowchart for one type of method for facilitators to receive user case assessment requests and to assist in the generation of care proposals according to the invention. Here the de-identified case is assessed by one or more providers (individual to the others) who self-select themselves based on time, interest, and availability to review the case, among other provider-specific factors 120. The facilitators may then transmit meaningful content based on one or more cases similar to the de-identified user's case and offer information in the form of (but not limited to) a care proposal, which may or may not include treatment recommendations and cost estimations based on cases similar to the user's submitted case 122. The facilitator or the facilitator's organization may then review the case proposal for the appropriate completeness prior to submission to the independent party 124 who then reviews the proposals for the appropriate completeness and then finalizes the case proposals for users who had opted for identified providers 128 or first ensures anonymization by redacting provider details for users who opted for an anonymous provider care proposal submission 126.

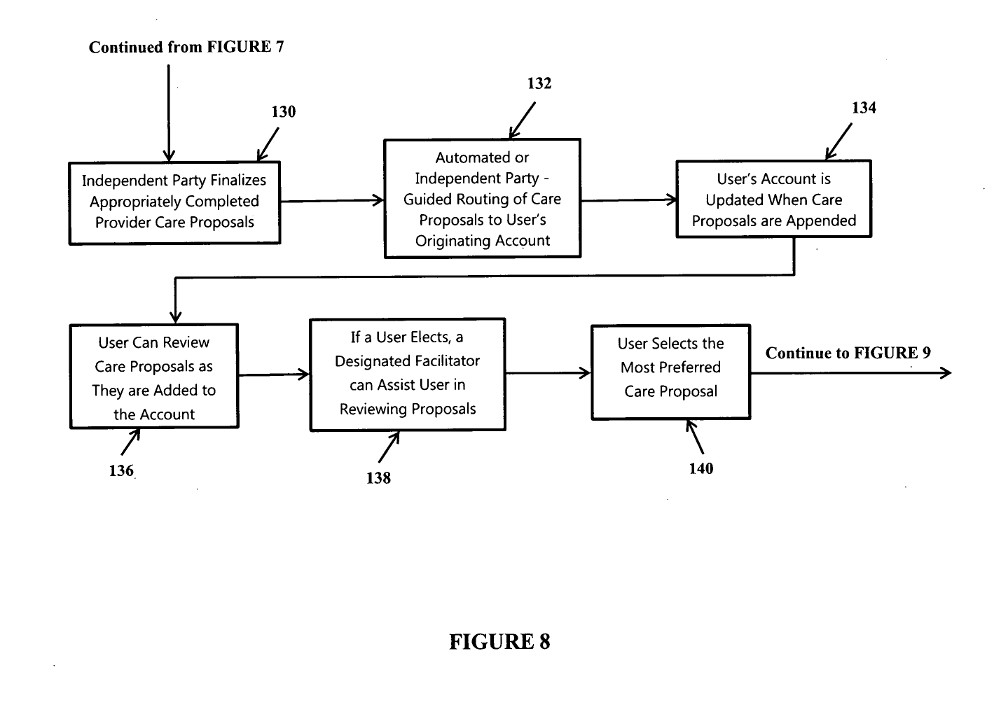

Referring now to FIG. 8 there is shown a block diagram of a flowchart for one method for a user selecting a care proposal when managing his or her medical data according to the invention. Once an independent party finalizes a care proposal 130, the proposal is then routed either automatically or semi-automatically by the independent party back to the user's originating data management account 132 following a software verification step to ensure matching metadata information. As the proposals are attached to the user's account, the user's account information is automatically updated by the server wherein the user receives subsequent active or passive notification that such action is occurring 134 by electronic communication means. The user may then critically review the provider proposals and content therein at any time 136. If the user so chooses, he or she may be able to contact an assistance network facilitator, such as a health concierge or a health care provider, to assist the user in reviewing proposals 138. Lastly, the user selects a provider, based on best fit and in consideration of the provider-delivered content and information, among other factors, for a care episode 140 that is privately delivered to the user.

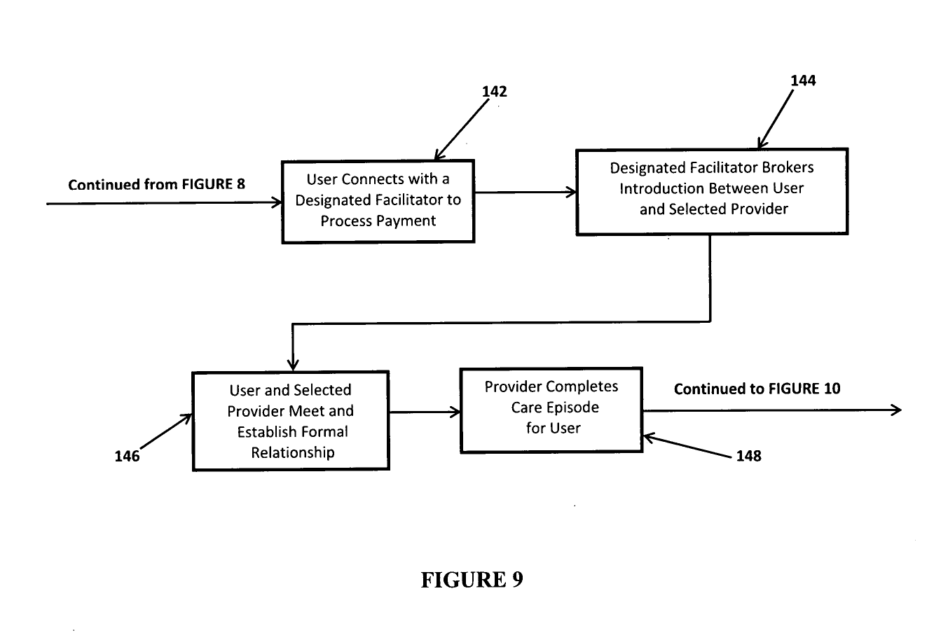

Referring now to FIG. 9 there is shown a block diagram of a flowchart of one type of method for a user paying for and in return receiving care according to the invention. At the time the user selects a desired provider for a care episode, the user pre-pays a designated facilitator for selected care based on such factors as the provider's rate as outlined in the delivered provider's care proposal 142. Next, following receipt of funds, the designated facilitator then brokers the introduction between the user and the selected health care provider 144. The user and the health care provider can then meet and establish a formal relationship 146, which can then lead to a completed user-provider care episode 148, by way of example a surgical procedure, treatment, or the like.

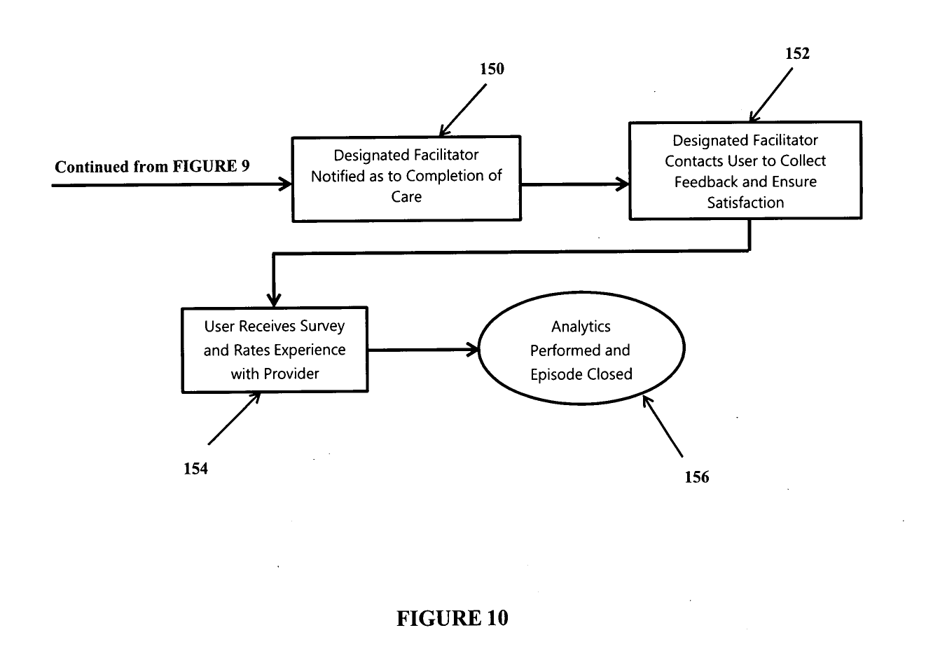

Referring now to FIG. 10 there is shown a block diagram of a flowchart for one type of method for completing a user's care episode according to the invention. Here the user informs their designated facilitator of completion of his or her provider-managed care episode 150. The designated facilitator may now collect the user's feedback to ensure an optimal user experience 152, an element of which by example may be a survey that translates into an assessment of the provider 154 to be delivered to designated parties of interest by the designated facilitator. Following data collection from the user and potentially from the provider, analytics of all collected data throughout the entire care episode would be performed prior to the care episode being officially closed 156. The analytics, by way of example but not of limitation, may include the creation and classification of medical data into groups for further analysis, such as imaging data findings and results, care quality and outcomes over a broad spectrum of data, which may include pricing and value data and the like.

A number of embodiments of the invention have been described. Nevertheless, it will be understood that various modifications may be made without departing from the spirit and scope of the invention. The medical data may include medical images, which may contain data stored within Digital Information in Communications and Medicine (DICOM) formatted files, or data stored consistent with other industry-standard and proprietary formats. The management system may be implemented on a single computing device or on multiple computing devices, such as a server farm or in a cloud-computing setting. Additionally, images and related data may be sent separately or combined in one transmission.

Information derived from metadata and extracted by an IO Management System may also be used in connection with billing, electronic medical records, and other health data uses that are not directly related to typical workflows. Likewise, further embodiments of the present invention may correlate the data extracted from the image metadata to information from billing, electronic medical record, and other health data systems.

Any of the embodiments described above may be performed by computers, including general purpose computers, connected (to a network or the Internet) computers, or combinations of client-server computers and/or peer-to-peer terminals. In one embodiment, for example, a computer system is provided on a server, and accessed by a user through a web interface. In accordance with one deployment, the system may be provisioned as software executing on a server in a cloud environment. Client devices such as mobile phones may also be provisioned with a client application to connect with the system over a network (e.g. the Internet).

It is contemplated for embodiments of the invention to extend to individual elements and concepts described herein, independently of other concepts, ideas or system, as well as for embodiments to include combinations of elements recited anywhere in this application. Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mention of the particular feature. Thus, the absence of describing combinations should not preclude the inventor from claiming rights to such combinations.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, USB and other removable media, hard disk drives, optical disks (e.g., Compact Disk Read-Only Memory (CD-ROMs), Digital Versatile Disks (DVDs), etc.), and flash drives, among others.

Although the present invention has been described with reference to specific exemplary embodiments, it will be evident that the various modification and changes can be made to these embodiments without departing from the broader spirit of the invention. Accordingly, the specification and drawings are to be regarded in an illustrative sense rather than in a restrictive sense.

What is claimed is:

1. A method for user managed health care by a user, comprising the steps of:
providing user medical data files containing metadata stored directly within said medical data files;
uploading said medical data files to a processing server wherein user personal information is redacted from said medical data files;
transmitting said redacted medical data files to one or more health care providers as directed by the user's inputs using a network connection;
sending to the user a care proposal by said one or more health care providers using said network connection; and
selecting a health care provider from said one or more health care providers by the user based on a user-selected care proposal.

2. The method according to claim 1, further comprising the step of:
uploading said user medical data to said processing server in accordance with HIPAA-compliant de-identification standards.

3. The method according to claim 1, further comprising the step of:
transmitting said redacted medical data files to one or more said health care providers in compliance with DICOM communication protocols or similar HIPAA compliant policies and procedures.

4. The method according to claim 1, further comprising the step of:
providing said user medical data files using metadata-bearing standards.

5. The method according to claim 1, further comprising the step of:
selecting a health care provider from said one or more health care providers by a facilitator based on data fields within said metadata from said user medical data files.

6. The method according to claim 1, further comprising the step of:
selecting a health care provider from said one or more health care providers by a facilitator based on data values within said metadata from said user medical data files wherein said data values consisting of a user identifier, a user physical location, a user medical condition, a user concern, a type of modality used to produce a series of medical images, a type of procedure performed or requested by the user and a type of medical image scan, wherein one or more of said data values may be used by said facilitator to select an appropriate health care provider.

7. The method according to claim 1, further comprising the step of:
selecting a health care provider from said one or more health care providers by an automated computer system based on data fields within said metadata from said user medical data files.

8. The method according to claim 1, further comprising the step of:
sending to the user a care proposal by said one or more health care providers using said network connection wherein the user requests a care episode with one or more of said health care providers.

9. The method according to claim 1, further comprising the step of:
sending a health related query by the user to said one or more health care providers before transmitting said medical data files.

10. The method according to claim 1, further comprising the step of:
uploading said user medical image data files to a processing server where said metadata within said medical data files is parsed for radiation exposure dose and then stored as a cumulative value that the user may then be able to track.

11. A system for user managed health care by a user, comprising:
a collection of one or more user medical data files containing metadata stored directly within said medical data files;
a processing server for uploading said user medical data files wherein personal information about the user is redacted from said medical data files;
a computer network connection for transmitting said redacted medical data files to one or more health care providers as directed by user inputs;
a care proposal sent to the user based on said medical data files by said one or more health care providers using said computer network connection; and
a health care provider selected from said one or more health care providers by the user based on a user-selected care proposal.

12. The system according to claim 11, wherein said processing server uploads said user medical data files in accordance with HIPAA-compliant de-identification standards.

13. The system according to claim 11, wherein said redacted medical data files are transmitted to one or more said health care providers in compliance with DICOM communication protocols or similar HIPAA compliant policies and procedures.

14. The system according to claim 11, wherein said user medical data files are created using metadata-bearing standards.

15. The system according to claim 11, wherein a facilitator selects a health care provider from said one or more health care providers based on data fields within said metadata from said user medical data files.

16. The system according to claim 11, wherein a facilitator selects a health care provider from said one or more health care providers based on data values within said metadata from said user medical data files wherein said data values consisting of a user identifier, a user physical location, a user medical condition, a user concern, a type of modality used to produce a series of medical images, a type of procedure performed or requested by the user and a type of medical image scan, wherein one or more of said data values may be used by said facilitator to select an appropriate health care provider.

17. The system according to claim 11, wherein said user medical data files may consist of genomics information, laboratory results, medical photos, medical imaging studies and medical device data.
